(19) United States
(12) Patent Application Publication
(10) Pub. No.: US 2018/0289047 A1
(43) Pub. Date: Oct. 11, 2018

(54) INSTANT RICE AND METHOD OF PRODUCING THE SAME

(71) Applicant: NAGATANIEN HOLDINGS CO., LTD., Tokyo (JP)

(72) Inventor: Michimasa Kumagai, Tokyo (JP)

(21) Appl. No.: 15/807,196

(22) Filed: Nov. 8, 2017

(30) Foreign Application Priority Data
Apr. 11, 2017 (JP) 2017-078205

(51) Int. Cl. A23L 7/196

(52) U.S. Cl. CPC A23L 7/1965; A23L 5/55

(57) ABSTRACT

A method of producing instant rice, includes bringing raw rice to absorb water to obtain water-absorbed rice, including holding a mixture of the raw rice and cooking water at a temperature of 75° C. to 80° C. for 20 to 60 min, and prior thereto, optionally preliminarily immersing the raw rice in water at a temperature of not more than 70° C., wherein a total amount of the cooking water and water absorbed by the raw rice in the preliminary immersion falls within a range of 150 to 190 parts by mass with respect to 100 parts by mass of the raw rice before the preliminary immersion, cooking the water-absorbed rice to obtain alpharized cooked rice, and drying the cooked rice.

### CROSS-REFERENCE TO RELATED APPLICATION

This application is based upon and claims the benefit of priority from Japanese Patent Application No. 2017-078205, filed Apr. 11, 2017, the entire contents of which are incorporated herein by reference.

### FIELDS

The present invention relates to instant rice and a method of producing the same.

### BACKGROUND

Needs have recently grown for foods that are easy to prepare without much time and easy to eat. Researches and developments of such foods have been conducted, and a number of such foods are commercially available. Even as for rice, products capable of saving time to cook for eating have been developed. In particular, alpharized rice and swelled puffed rice are widely used, for example, as general foods on the market, preserved foods for disaster and portable rations for mountain-climbing because of their excellent shelf-life, lightweight and unbulky characteristics.

In Japan, where rice is the chief staple of the diet, the requirement for the flavor and the like is very high. In other countries as well, the requirement for the flavor and the like is growing more and more.

Conventionally, various producing methods have been developed to obtain dehydrated rice that is satisfactory as an instant food not only from the viewpoint of texture or flavor after rehydration but also from the rehydration time.

For example, Jpn. Pat. Appln. KOKOKU Publication No. 34-5730 discloses steaming water-absorbed rice to evenly gelatinize its surface, immersing the rice in an enriched liquid containing vitamins and the like to make it sufficiently absorb water, steaming the rice to completely alpharize it, and then drying the rice by hot air to obtain dehydrated rice.

In this literature, the primary condition to produce dehydrated rice that can quickly be rehydrated is to make rice sufficiently absorb water preferably to have a water content of 40% or more before heating and alpharizing it. For this reason, raw rice that has absorbed water is briefly steamed to alpharize its surface, thus improving the raw rice in water absorbency. After the water content is increased to 45% to 50%, the rice is completely alpharized.

Jpn. Pat. Appln. KOKAI Publication No. 52-102453 discloses an instant rice producing method including the same process as in Jpn. Pat. Appln. KOKOKU Publication No. 34-5730. In this method, the water content after steaming process for complete alpharization is limited to 40% to 55%. In this literature, if the water content is less than 40%, instant rice obtained, when it is rehydrated by hot water, shows poor viscoelasticity like undercooked rice. If the water content is more than 55%, instant rice obtained has rice grains excessively adhering to each other, which hinders even rehydration of the instant rice.

Jpn. Pat. Appln. KOKAI Publication No. 56-151472 discloses an instant rice producing method in which alpharized rice having water content of 50% to 65% is immersed in water for 30 min or more such that the water content increases by 10% or more but does not exceed 85%, and after that, the rice is dried by hot air or the like, not by freeze-drying.

### SUMMARY

The dehydrated rice described in Jpn. Pat. Appln. KOKOKU Publication No. 34-5730 is rehydrated in 50 min by water or in 25 min by hot water. The quick-cooking property is still insufficient.

The producing method described in Jpn. Pat. Appln. KOKAI Publication No. 52-102453 assumes performing a swelling process by hot air at 200° C. or more after the steaming process. That is, this method is a method of producing puffed rice. Jpn. Pat. Appln. KOKAI Publication No. 52-102453 also describes causing rice before complete water absorption to absorb an emulsified liquid of oil to prevent rice grains from adhering to each other. Instant rice obtained by this method, when it is rehydrated, shows texture and flavor that are different from those of normal cooked rice and is not satisfactory as rice.

Jpn. Pat. Appln. KOKAI Publication No. 56-151472 describes that water-content control is performed such that the water content of alpharized rice with a water content of 50% to 65% will increase by 10% or more but will not exceed 85%. According to this literature, this allows whole rice grains after drying to have a porous structure, thereby attaining instant rice with an excellent rehydration property that hot water can easily permeate. In the method described in Jpn. Pat. Appln. KOKAI Publication No. 56-151472, the alpharized rice with a water content of 50% to 65% is obtained by adding water to water-absorbed raw rice and performing an alpharization process on the rice at a stretch using a rice cooker, a steamer or the like. However, in such an alpharization process, starch is eluted from the rice grains, and the rice grains deform or agglomerate. As a result, the drying efficiency lowers, and the flavor degrades. Hence, the water immersion of the alpharized rice as disclosed in this literature seems preferable in terms of keeping the rice grains apart from each other.

Additionally, in the method described in Jpn. Pat. Appln. KOKAI Publication No. 56-151472, the alpharized rice is dried after the water content of the alpharized rice is controlled not to fall outside the range of 50% to 85%. However, as pointed out by Jpn. Pat. Appln. KOKAI Publication No. 52-102453, if the water content exceeds 55%, the rice grains excessively deform or adhere to each other, resulting in a problem from the viewpoint workability and drying efficiency.

As described above, presently, there is no dehydrated rice satisfactory as an instant food from the viewpoint of the rehydration time and the texture, flavor, and outer appearance after rehydration. In addition, there is a problem from the viewpoint workability and drying efficiency in the production.

That is, the conventional instant rice producing method can hardly simultaneously implement satisfactory rehydration properties and workability in the production.

It is therefore an object of the present invention to enable efficient production of instant rice that is rehydrated in a short time and exhibits excellent flavor, texture, and outer appearance after rehydration.

According to a first aspect of the present invention, there is provided a method of producing instant rice, comprising:
bringing raw rice to absorb water to obtain water-absorbed rice, including
   holding a mixture of the raw rice and cooking water at a temperature of 75° C. to 80° C. for 20 to 60 min, and
   prior thereto, optionally preliminarily immersing the raw rice in water at a temperature of not more than 70° C., wherein a total amount of the cooking water and water absorbed by the raw rice in the preliminary immersion falls within a range of 150 to 190 parts by mass with respect to 100 parts by mass of the raw rice before the preliminary immersion;
cooking the water-absorbed rice to obtain alpharized cooked rice; and
drying the cooked rice.

According to a second aspect of the present invention, there is provided instant rice produced by the method according to the first aspect.

### BRIEF DESCRIPTION OF THE DRAWING

FIG. 1 is a graph showing time-rate changes in temperature of rice.

### DETAILED DESCRIPTION

An embodiment of the present invention will be described below.

A method of producing instant rice according to an embodiment of the present invention comprises:
bringing raw rice to absorb water to obtain water-absorbed rice, including
   holding a mixture of the raw rice and cooking water at a temperature of 75° C. to 80° C. for 20 to 60 min, and
   prior thereto, optionally preliminarily immersing the raw rice in water at a temperature of not more than 70° C., wherein a total amount of the cooking water and water absorbed by the raw rice in the preliminary immersion falls within a range of 150 to 190 parts by mass with respect to 100 parts by mass of the raw rice before the preliminary immersion;
cooking the water-absorbed rice to obtain alpharized cooked rice; and
drying the cooked rice.

The above-described method will be described below in the order of 1. water absorption step, 2. rice cooking step, and 3. drying step.

1. Water Absorption Step

First, a mixture of raw rice that has undergone preliminary immersion and cooking water is held at a temperature of 75° C. to 80° C. for 20 to 60 min to obtain water-absorbed rice. It is noted that the preliminary immersion described below can be omitted as will be explained later.

(Preliminary Immersion)

The raw rice can be preliminarily immersed in water at 70° C. or less, thereby obtaining preliminarily-immersed rice.

The raw rice is rice obtained by removing chaff from paddy rice.

The raw rice is, for example, rice obtained by removing bran or bran and germ from brown rice, for example, buzukimai (brown rice with the germ and bran removed to varying degrees), germ rice or polished white rice, or wash-free rice obtained by removing bran powder from polished white rice.

The raw rice is not particularly limited and any rice can be used as long as it is ordinary uruchi rice for cooking. The raw rice is, for example, Japonica rice, Indica rice, or Javanica rice. The raw rice can be rice produced in Japan or rice such as California rice that is a medium grain rice variety produced in another country.

The rice polishing ratio of the raw rice is, for example, 88 to 93 mass %, more preferably, 91 to 93 mass % with respect to brown rice. If rice obtained by removing the pericarp and the seed coat while leaving the aleurone layer and the subaleurone layer or rice obtained by removing the pericarp, the seed coat, and the aleurone layer while leaving the subaleurone layer is used as the raw rice, the stickiness on rice grains decreases at time of alpharization, and the workability is further improved. If polished rice whose rice polishing ratio falls within the above rang is used, sticking between rice grains after alpharization is reduced because the aleurone layer and the subaleurone layer, or the subaleurone layer remains on the rice grain surfaces. Consequently, air circulates well among the rice grains, and the drying efficiency improves. In addition, improvement of the rehydration speed is also observed.

The water content of the raw rice is typically 16% by mass or less, for example, 14% by mass to 15% by mass.

Preliminary immersion is done such that the mass of preliminarily-immersed rice is preferably about 140 parts by mass or less, for example, about 130 parts by mass with respect to 100 parts by mass of raw rice before preliminary immersion.

The temperature of water for preliminary immersion is 70° C. or less, preferably 20° C. to 50° C. The preliminary immersion time is preferably 2 hrs or less, for example, 30 to 60 min.

The above-described preliminary immersion can be omitted. For example, if wash-free rice or rice with little bran powder remaining is used as the raw rice, the above-described preliminary immersion step may be omitted.

However, if rice obtained by normal hulling such as buzukimai, germ rice, or polished white rice is used as the raw rice, the raw rice is preferably preliminarily immersed in water. The rice obtained by normal hulling has much bran powder remaining on the surface. The bran powder remaining on the surface of the rice is a factor to reduce the water absorption speed and water absorption rate of the raw rice. Therefore, if the above-described rice is used as the raw rice, the raw rice is preferably preliminarily immersed in water to improve the water absorption rate in a high-temperature water absorption step to be described later. It is noted that the raw rice may be washed as needed before preliminary immersion.

(High-Temperature Water Absorption)

Next, cooking water is added to the raw rice or preliminarily-immersed rice. The amount of cooking water is adjusted such that the total amount of the cooking water and the water absorbed in the preliminary immersion falls within the range of 150 to 190 parts by mass with respect to 100 parts by mass of raw rice before preliminary immersion.

Then, the mixture of the preliminarily-immersed rice and the cooking water is held at a temperature of 75° C. to 80° C. for 20 to 60 min to obtain water-absorbed rice.

The absorption of the cooking water by the preliminarily-immersed rice can be carried out to such a degree that cooking water is rarely recognized as free water. Hence, the mass of the obtained water-absorbed rice falls within the range of, for example, 240 to 290 parts by mass, preferably, 240 to 250 parts by mass or 250 to 290 parts by mass with respect to 100 parts by mass of raw rice before preliminary immersion.

The cooking water may contain known fats and oils, polysaccharide thickeners, dextrin or the like, or may not. If the cooking water contains known oils and fats, polysaccharide thickeners, dextrin or the like, agglomeration of cooked rice due to an increased stickiness, which is observed in cooked rice of a high water content, is suppressed, and thus the workability in the drying step later improves.

The cooking water may contain any seasoning as long as it does not hinder water permeation into the rice.

The temperature of the mixture of the preliminarily-immersed rice and the cooking water can be controlled using, for example, a heating device capable of adjusting a temperature. The heating device capable of adjusting a temperature is, for example, a rice cooker capable of adjusting a temperature such as a tunnel-type continuous rice cooker or an Induction Heating (IH) rice cooker, a steam room, or a hot water bath.

As described above, in the high-temperature water absorption, the mixture of the preliminarily-immersed rice and the cooking water is held at a temperature of 75° C. to 80° C. for 20 to 60 min. The temperature and holding time of the mixture can appropriately be adjusted in accordance with the type, breed and the like of rice.

The temperature of the mixture of the preliminarily-immersed rice and the cooking water is held at 75° C. to 80° C. If the temperature is too low, a sufficient amount of water cannot be absorbed or it takes a very long time for the rice to absorb a sufficient amount of water.

For example, if the raw rice is immersed in hot water at 50° C. for 60 min, the mass of the raw rice after the immersion is about 130 parts by mass with respect to 100 parts by mass of raw rice before the immersion. The water content of the raw rice after the immersion is about 33%. If the raw rice is immersed in hot water at 70° C. for 1 hr, the mass of the raw rice after the immersion is about 170 parts by mass with respect to 100 parts by mass of raw rice before the immersion. The water content of the raw rice after the immersion is about 50%.

In either case, the water absorption amount is smaller than the water absorption amount achieved in the above-described water absorption step, that is, 150 to 190 parts by mass with respect to 100 parts by mass of raw rice before the immersion. If a sufficient amount of water cannot be absorbed, a large quantity of cooking water remains as free water. If the rice is cooked in a state in which a large amount of cooking water remains, starch is eluted from the surface of the rice, resulting in the increased stickiness on the surface of the cooked rice.

If the temperature of the mixture of the preliminarily-immersed rice and the cooking water is too high, the stickiness on the surface of the rice increases, and the workability in the drying step later lowers. In addition, the rice readily loses its shape.

The time to hold the mixture at the above-described temperature is 20 to 60 min, preferably, 25 to 50 min, and more preferably, 30 to 50 min. In holding the mixture at the above-described temperature, depending on the shape or volume of a container that stores the mixture of the preliminarily-immersed rice and the cooking water, a difference in temperature of rice is observed between the center and periphery of the container. To decrease the temperature difference and enable even water absorption, hot water at a temperature equal to or less than the alpharization temperature, that is, hot water whose temperature is adjusted to 50° C. to 70° C. in advance is used as the cooking water, and the cooking water and the preliminarily-immersed rice are mixed. The mixture may be heated as needed.

In this step, it is possible to make the raw rice before cooking absorb most of the cooking water, thereby obtaining water-absorbed rice of a high water content. Hence, in the subsequent rice cooking step, even if the amount of free cooking water around the rice grains is small, cooked rice of a high water content can be obtained. This can suppress elution of starch and reduce adhesiveness.

If the cooking water is completely absorbed, the mass of the water-absorbed rice obtained in this step falls within the range of 250 to 290 parts by mass with respect to 100 parts by mass of raw rice.

It is noted that the above-described water absorption step and the subsequent rice cooking step may continuously be performed using a rice cooker capable of adjusting a temperature such as a tunnel-type continuous rice cooker or an IH rice cooker or any heating device. Alternatively, only the water absorption step may be performed using a steam room or a hot water tank, and the rice cooking step may be performed using another heating device.

The amount of cooking water in a case in which the preliminary immersion step is omitted is set to the range of 150 to 190 parts by mass with respect to 100 parts by mass of raw rice.

2. Rice Cooking Step

Next, the water-absorbed rice is cooked to obtain alpharized cooked rice.

Rice cooking is performed by heating the water-absorbed rice so as not to change the water content of the water-absorbed rice in a state in which almost no cooking water remains. Rice cooking is performed by, for example, heating or steaming the water-absorbed rice using any heating device.

The heating device is, for example, a rice cooker capable of adjusting a temperature such as a tunnel-type continuous rice cooker or an IH rice cooker, a steamer, or a pressure cooker.

The rice cooking may be performed under an atmospheric pressure or under a high pressure.

In atmospheric-pressure rice cooking, the rice cooking time is typically 10 to 40 min. In high-pressure rice cooking, the rice cooking time is typically 5 to 20 min.

The rice cooking temperature is not particularly limited as long as it is a temperature at which the starch of the water-absorbed rice is completely alpharized. The rice cooking temperature is, for example, 100° C. or more. If atmospheric-pressure steam is used as a heat source, the rice cooking temperature is, for example, 100° C. If an IH rice cooker is used, the rice cooking temperature is, for example, 120° C. to 160° C.

If the cooking water is completely absorbed by the water-absorbed rice in the water absorption step, the water-absorbed rice is heated so as not to change the water content of the water-absorbed rice in a state in which no cooking water exists, thereby obtaining alpharized cooked rice.

If the cooking water remains after the water absorption step, the water-absorbed rice may be heated together with the remaining cooking water. The smaller the amount of water remaining around the water-absorbed rice at the time of rice cooking is, the lower the stickiness on the surface of the obtained cooked rice is.

In the rice cooking step, any seasoning may be added as long as it does not increase the stickiness on the surface of the cooked rice.

The mass of the cooked rice falls within the range of 250 to 280 parts by mass with respect to 100 parts by mass of raw rice. The mass of the cooked rice almost equals the mass of the water-absorbed rice although a small increase/decrease in mass is observed as compared to the water-absorbed rice. If the mass of the cooked rice is less than 250 parts by mass with respect to 100 parts by mass of raw rice, swelling of the raw rice at the time of rice cooking is insufficient, and permeation of hot water into the rice grains of instant rice obtained after drying is slow. Additionally, even if the rice is rehydrated, alpharization is insufficient, and the texture is like uncooked rice and hard. If the mass of the cooked rice exceeds 280 parts by mass, the cooked rice has very soft properties. Hence, the workability is poor, and adhesiveness of rice grains is high, which not only results in a low drying efficiency but also may cause the rice grains to agglomerate or crush. Furthermore, if excessive starch eluted in rice cooking dries, permeation of hot water is suppressed. As a result, the instant rice after rehydration not only has a relatively hard texture but also partially includes a hard portion, and the texture and flavor are impaired.

The water content of the cooked rice obtained in this step is about 65% to 69%.

3. Drying Step

The cooked rice is dried to obtain instant rice.

The cooked rice is dried until the water content of the cooked rice after drying decreases to, for example, 8% or less. The cooked rice is preferably dried before the alpharized starch retrogrades to β starch again.

The drying of the cooked rice is done by, for example, hot air drying or reduced-pressure drying. The hot air drying is performed using, for example, a belt-type circulation dryer or a static shelf-type hot air dryer. The temperature of hot air is 70° C. or more and preferably a temperature that does not swell the rice grains.

The dried cooked rice is loosened up a little as needed and put through a sieve with an opening of about 3 to 4 meshes, thereby obtaining instant rice with independent rice grains.

According to the above-described method, it is possible to obtain cooked rice of a high water content while suppressing elution of rice starch. That is, according to this method, it is possible to efficiently produce instant rice capable of being rehydrated in a short time and providing excellent flavor, texture, and outer appearance after rehydration. The present inventor considers the reason for this as follows.

In normal rice cooking, generally, raw rice is preliminarily immersed and then cooked after cooking water is added such that the total amount of the cooking water and water absorbed in the preliminary immersion falls within the range of 110 to 120 parts by mass with respect to 100 parts by mass of raw rice before preliminary immersion.

On the other hand, in the above-described method, rice is cooked after a large amount of cooking water is added such that the total amount of the cooking water and the water absorbed in the preliminary immersion falls within the range of 150 to 190 parts by mass with respect to 100 parts by mass of raw rice before preliminary immersion. However, if rice cooking is performed in this state, most of the cooking water exists around the rice grains in a free water state. As a result, alpharized rice starch is eluted to the cooking water on the periphery and causes a rice porridge state or excessive stickiness on the cooked rice surfaces. This increases the adhesiveness between the rice grains and degrades the workability. In addition, the shapes of the rice grains are lost, adversely affecting the flavor and texture.

When rice to which water is added is heated to a temperature more than 80° C., alpharization (bonds in branched molecules including amylose and amylopectin break, and the structure of rice starch changes to such a state that allows water molecules to freely enter) of rice starch occurs. The alpharization of rice gradually progresses from the surfaces to inside the rice grains. Along with the alpharization, the rice absorbs water and swells. On the surfaces of the rice grains, the alpharization quickly progresses as compared to the inside, and the swelling ratio is high. For this reason, if the rice is exposed to hot water at a temperature more than 80° C., starch on the surfaces of the rice grains quickly hydrates and swells, and the surfaces crack in an early stage. Accordingly, the rice starch is readily eluted.

On the other hand, if a mixture of raw rice and cooking water is held at a temperature of 75° C. to 80° C., alpharization moderately progresses from the surfaces to inside the rice grains. In other words, the rice grains obtain higher water absorption ability and hydration ability to the inside before rice starch near the surfaces is completely alpharized. That is, water absorption and swelling progresses to the inside without abruptly expanding the surfaces of the rice grains. Hence, when the mixture of the raw rice and the cooking water is held at a temperature of 75° C. to 80° C., a large amount of water can evenly be permeated to the center of each rice grain while suppressing elution of the rice starch. It is therefore possible to obtain water-absorbed rice that has a high water content with elution of rice starch suppressed.

If rice is immersed in water for a long time, elution of rice starch occurs. Hence, the time to bring raw rice in contact with water is 20 to 60 min in order to obtain water-absorbed rice while suppressing elution of rice starch.

To obtain water-absorbed rice of a high water content while suppressing elution of rice starch in this immersion time, the mixture of the raw rice and cooking water is held at a temperature of 75° C. to 80° C.

If the mixture of the raw rice and the cooking water is held at a temperature less than 75° C., the immersion time exceeds 60 min to obtain water-absorbed rice of a desired water content, and elution of rice starch increases.

The higher the temperature of the mixture of the raw rice and the cooking water is, the shorter the immersion time to obtain water-absorbed rice of a desired water content is. However, if the mixture is held at a temperature more than 80° C., alpharization and swelling on rice grain surfaces quickly progress. Hence, the surfaces crack, and elution of rice starch increases.

The amount of cooking water is adjusted such that the total amount of the cooking water and water absorbed by the raw rice in preliminary immersion falls within the range of 150 to 190 parts by mass with respect to 100 parts by mass of raw rice before preliminary immersion.

If the amount of cooking water falls below the range, water-absorbed rice obtained by holding the mixture of the raw rice and the cooking water at a temperature of 75° C. to 80° C. for 20 to 60 min does not contain sufficient water. Hence, when such water-absorbed rice is heated, cooked rice of an insufficient water content is obtained. If the water content of cooked rice is insufficient, instant rice after drying cannot form fine cracks that help rehydration.

If the amount of cooking water exceeds the range, water-absorbed rice obtained by holding the mixture of the raw rice and the cooking water at a temperature of 75° C. to 80° C. for 20 to 60 min contains excessive water. Hence, when such water-absorbed rice is heated, cooked rice with increased stickiness is obtained.

When the mixture of the raw rice and the cooking water is held at a temperature of 75° C. to 80° C. for 20 to 60 min, water-absorbed rice of a high water content which has absorbed almost all cooking water and has almost no free cooking water can be obtained.

When the obtained water-absorbed rice of a high water content is heated so as not to change the water content in a state in which almost no free water exists, cooked rice of a high water content, whose stickiness on the surface is reduced and which is sufficiently alpharized to the center, can be obtained.

Since the cooked rice has a high water content, instant rice obtained by drying the cooked rice has rice grains with a number of fine cracks formed by drying shrinkage. Hence, the instant rice allows hot water or water to evenly and quickly permeate and, when rehydrated, provides flavor and texture comparing favorably with cooked rice.

Additionally, in this cooked rice, less starch is eluted in the producing process. Hence, when the cooked rice is dried, instant rice that allows water or hot water to evenly and quickly permeate without being hindered by the starch eluted to the rice surfaces can be obtained. Furthermore, since less starch is eluted in the cooked rice, stickiness on the surfaces is decreased. The cooked rice thus hardly agglomerates. Hence, the cooked rice can efficiently be dried, and the rice grains of instant rice obtained after the drying are deformed or broken little.

Therefore, according to the above-described method, it is possible to efficiently produce instant rice capable of being rehydrated in a short time and providing excellent flavor, texture, and outer appearance after rehydration.

As can be seen from the related art, since normal cooked rice or steamed rice having a water content of 60% or more has high stickiness, the workability is poor. On the other hand, in the above-described method, since water-absorbed rice of a high water content can be obtained in the water absorption step, elution of alpharized rice starch is suppressed at the time of rice cooking. As a result, the stickiness on the cooked rice surfaces is decreased, and there is little adhered and agglomerated rice. This improves the workability and raises efficiency in drying the cooked rice. In addition, since there is little adhered and agglomerated rice, the rice grains after drying have an excellent shape. Furthermore, in the above-described method, since elution of rice starch is suppressed at the time of rice cooking, obtained instant rice allows hot water or water to easily permeate at the time of rehydration.

The above-described instant rice can be used as, for example, emergency rations, rice with poured soup, or a cup of instant rice to be prepared by draining hot water or water used for rehydration and then seasoning. In addition, the instant rice according to the present invention can widely be used not only as instant foods pursuing convenience but also as preserved foods for disaster.

<Influence of Product Temperature and Immersion Time of Rice on Water-Absorption Rate of Rice>

(Preparation of Water-Absorbed Rice)

### TEST EXAMPLE 1

Fifty grams of wash-free processed Hitomebore was put in a 200-mL beaker, and 120 mL of hot water at 75° C. was poured into the beaker. This was settled in a water bath set to 80° C. for 15 min. During this time, a temperature sensor was put in the rice at the center of the beaker to measure the temperature of the rice. In addition, the time during which the temperature of the rice was held at 75° C. to 80° C. was measured. After the settling, free water was separated, thereby obtaining water-absorbed rice.

### TEST EXAMPLE 2

Water-absorbed rice was prepared in accordance with the same procedure as described concerning Test Example 1 except that the settling time was changed from 15 min to 30 min.

### TEST EXAMPLE 3

Water-absorbed rice was prepared in accordance with the same procedure as described concerning Test Example 1 except that the settling time was changed from 15 min to 40 min.

### TEST EXAMPLE 4

Water-absorbed rice was prepared in accordance with the same procedure as described concerning Test Example 1 except that the set temperature of the water bath was changed from 80° C. to 75° C., and the settling time was changed from 15 min to 60 min.

### TEST EXAMPLE 5

Water-absorbed rice was prepared in accordance with the same procedure as described concerning Test Example 1 except that the set temperature of the water bath was changed from 80° C. to 75° C., and the settling time was changed from 15 min to 70 min.

### TEST EXAMPLE 6

Water-absorbed rice was prepared in accordance with the same procedure as described concerning Test Example 1 except that the set temperature of the water bath was changed from 80° C. to 75° C., and the settling time was changed from 15 min to 90 min.

### TEST EXAMPLE 7

Water-absorbed rice was prepared in accordance with the same procedure as described concerning Test Example 1 except that the set temperature of the water bath was changed from 80° C. to 72° C., and the settling time was changed from 15 min to 80 min.

(Measurement Result of Temperature of Rice)

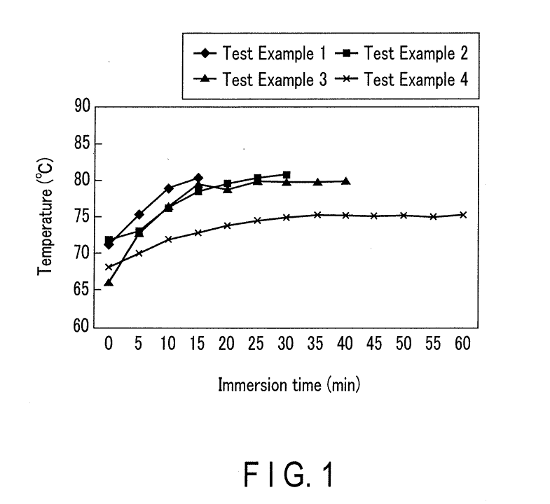

FIG. 1 shows the measurement result of the temperature of rice.

FIG. 1 is a graph showing time-rate changes in temperature of rice according to Test Examples 1 to 4. The abscissa of this graph represents the time to settle the beaker in the water bath, and the ordinate represents the temperature of rice.

For each of Test Examples 1 to 6, the time during which the temperature of rice was held at 75° C. to 80° C. was measured. For Test Example 7, the time during which the temperature of rice was held at 72° C. was measured.

(Measurement of Mass of Water-Absorbed Rice)

The mass of water-absorbed rice obtained in each of Test Examples 1 to 7 was measured.

Table 1 summarizes the measurement result of the time to hold the temperature of rice at 75° C. to 80° C. or at 72° C. and the measurement result of the mass of the water-absorbed rice.

TABLE 1

| | | | | Mass of Water- |
|---|---|---|---|---|
| | | | | Absorbed Rice |
| | | | | (parts by mass with |
| | Set Temperature | Time to hold | Time to hold | respect to 100 |
| | of Water Bath | Temperature at 75° C. | Temperature at | parts by mass of |
| | (° C.) | to 80° C. (min) | 72° C. (min) | raw rice) |
| Test Example 1 | 80 | 12 | — | 178 |
| Test Example 2 | 80 | 23 | — | 235 |
| Test Example 3 | 80 | 33 | — | 256 |
| Test Example 4 | 75 | 30 | — | 244 |
| Test Example 5 | 75 | 40 | — | 266 |
| Test Example 6 | 75 | 60 | — | 310 |
| Test Example 7 | 72 | — | 52 | 234 |

As is apparent from the temperature measurement results of Test Examples 1 to 3, when the beaker was settled in the water bath set at 80° C. for 15 min, 30 min, and 40 min, the times to hold the temperature of rice at 75° C. to 80° C. were 12 min, 23 min, and 33 min, respectively.

As is apparent from the temperature measurement results of Test Examples 4 to 6, when the beaker was settled in the water bath set at 75° C. for 60 min, 70 min, and 90 min, the times to hold the temperature of rice at 75° C. were 30 min, 40 min, and 60 min, respectively.

As is apparent from the temperature measurement result of Test Example 7, when the beaker was settled in the water bath set at 72° C. for 80 min, the time to hold the temperature of rice at 72° C. was 52 min.

As shown in Table 1, Test Example 2 achieved a water content higher than in Test Example 1. Test Example 4 achieved a water content higher than in Test Example 2. Test Example 3 achieved a water content higher than in Test Example 4. Test Example 5 achieved a water content higher than in Test Example 3. Test Example 6 achieved a water content higher than in Test Example 5. That is, as the time to hold the temperature of rice at 75° C. to 80° C. became longer, water-absorbed rice of a higher water content was achieved.

Test Example 3 achieved a water content higher than in Test Example 4. That is, as the temperature of the rice to hold became higher, water-absorbed rice of a higher water content was achieved.

Test Example 2 achieved almost the same water content in a shorter time than in Test Example 7. That is, as the temperature of the rice became higher, water-absorbed rice of a high water content could be achieved in a shorter time.

When the water-absorbed rice obtained in Test Examples 1 to 7 was steamed at 100° C. with a lid closed, the mass of obtained cooked rice was hardly changed from that of the water-absorbed rice before rice cooking.

(Preparation of Instant Rice)

### EXAMPLE 1

Two hundred grams of polished white Hitomebore rice was washed and preliminarily immersed for 1 hr. The mass of the preliminarily-immersed rice was 258 g. That is, the mass of the preliminarily-immersed rice was 129 parts by mass with respect to 100 parts by mass of raw rice.

The obtained preliminarily-immersed rice was put in a lidded aluminum container, and 262 g of cooking water at 50° C. was added. The total mass of the cooking water and water absorbed in the preliminary immersion was 320 g. That is, the total mass of the cooking water and the water absorbed in the preliminary immersion was 160 parts by mass with respect to 100 parts by mass of raw rice. The mixture of the preliminarily-immersed rice and the cooking water was held and heated in a steam oven set at 77° C. for 35 min to obtain water-absorbed rice. The time to hold the temperature of the mixture of the preliminarily-immersed rice and the cooking water at 75° C. to 80° C. was 30 min.

Next, the water-absorbed rice was steamed at 100° C. for 30 min, thereby obtaining alpharized cooked rice. The mass of the obtained cooked rice was 528 g, that is, 264 parts by mass with respect to 100 parts by mass of raw rice.

The cooked rice was placed on a wire net, dried by hot air at 80° C., and put through a 3-mesh sieve, thereby obtaining 178 g of instant rice.

### COMPARATIVE EXAMPLE 1

Cooked rice was prepared in accordance with the same procedure as described concerning Example 1 except that a mixture of preliminarily-immersed rice and cooking water was directly steamed at 100° C. for 40 min without holding and heating it in a steam oven set at 77° C. for 35 min.

The time to hold the temperature of the mixture of the preliminarily-immersed rice and the cooking water at a temperature of 75° C. to 80° C. was about 1 min. The mass of the obtained cooked rice was 520 g, that is, 260 parts by mass with respect to 100 parts by mass of raw rice. Next, the obtained cooked rice was dried by hot air, and put through a sieve, as in Example 1, thereby obtaining 178 g of instant rice.

(Evaluation of Workability)

In the cooked rice according to Comparative Example 1, as compared to Example 1, stickiness on the rice grain surfaces was high, and the rice grains tended to adhere to each other and agglomerate when they were placed on the wire net at the time of drying. In addition, rice produced by drying the cooked rice obtained by Comparative Example 1 included hard rice grains as compared to rice produced by drying the cooked rice obtained by Example 1, and it was not easy to put them through the sieve. As for the shape, many broken rice grains were observed in the instant rice obtained by Comparative Example 1. Hence, Example 1 was more excellent than Comparative Example 1 in workability.

### (Sensory Evaluation)

For each of Example 1 and Comparative Example 1, 50 g of instant rice obtained was put in a paper cup, 230 g of hot water was added to it, and then the cup was lidded and held for 5 min, thereby rehydrating the instant rice. After the rehydration, the instant rice of Example 1 was soft and had elasticity unique to cooked rice and a texture approximate to cooked rice. The instant rice had the quality of rice capable of being used for ochazuke and the like without any problem.

The instant rice of Comparative Example 1 also had a texture approximate to cooked rice after the rehydration. However, the rice grain surfaces were hard a little. Additionally, the instant rice of Comparative Example 1 included many broken or deformed rice grains after the rehydration, and the outer appearance and flavor were poor, as compared to the instant rice of Example 1.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A method of producing instant rice, comprising:
bringing raw rice to absorb water to obtain water-absorbed rice, including
holding a mixture of the raw rice and cooking water at a temperature of 75° C. to 80° C. for 20 to 60 min, and
prior thereto, optionally preliminarily immersing the raw rice in water at a temperature of not more than 70° C., wherein a total amount of the cooking water and water absorbed by the raw rice in the preliminary immersion falls within a range of 150 to 190 parts by mass with respect to 100 parts by mass of the raw rice before the preliminary immersion;
cooking the water-absorbed rice to obtain alpharized cooked rice; and
drying the cooked rice.

2. The method according to claim 1, wherein a mass of the cooked rice falls within a range of 250 to 280 parts by mass with respect to 100 parts by mass of the raw rice.

3. Instant rice produced by the method according to claim 1.

4. Instant rice produced by the method according to claim 2.
